(19) United States
(12) Patent Application Publication
(10) Pub. No.: US 2009/0227309 A1
(43) Pub. Date: Sep. 10, 2009

(54) Playing Method Of Card Game And Game Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/138,063

(22) Filed: Jun. 12, 2008

Related U.S. Application Data
(60) Provisional application No. 61/034,750, filed on Mar. 7, 2008.

(51) Int. Cl. A63F 13/02; A63F 13/10; A63F 13/12; A63F 9/24

(52) U.S. Cl. 463/13; 273/292; 463/30; 463/43; 463/27

(57) ABSTRACT

A method of playing card games, according to the present invention, includes the steps of: (a) dealing a predetermined number of cards as player's cards and dealing a predetermined number of cards as banker's cards from among plural types of cards; (b) varying a predetermined card included in the player's cards to another kind of card at a predetermined timing in a case where the player's cards include the predetermined card for a duration from dealing of cards to an end of a game in (a); and (c) determining a winner or a loser by comparing hands of the player's cards with hands of the banker's cards.

### CROSS-REFERENCE TO RELATED APPLICATIONS

This application claims priority of U.S. Provisional Application No. 61/034,750 filed on Mar. 7, 2008. The contents of this application are incorporated herein by reference in their entirety.

### BACKGROUND OF THE INVENTION

1. Field of the Invention

The present invention relates to a method of playing card games and a game machine.

2. Description of the Related Art

Conventionally, games played at real casinos include those employing cards (trumps). The above games employing cards include poker, blackjack, and baccarat, for example. In recent years, players have also enjoyed poker games such as a PAIGOW poker and a Caribbean Stud poker.

With the prevalence of gaming places and game arcades in recent years, game machines have been introduced which allow computers to take over a dealer in such games employing cards, such that players can casually enjoy the games as described above. In this game machine, the dealing of cards and the determination of what numbers or symbols of the dealt cards might be are executed by gaming machines executing programs. The players recognize what cards have been dealt by way of images of the cards displayed on the display devices such as liquid crystal displays, and perform game operation with the use of input devices. Such game machines are disclosed in US Published Patent Application No. 20070004512.

Further, game machines also exist which are capable of performing the PAIGOW poker. The rules of the PAIGOW poker are partially different from those of other poker games. First, seven cards are dealt to each of the persons consisting of a banker and players. Then, the banker and players divide seven cards into a group of five cards and a group of two cards, respectively. Further, they compare hands of five cards with each other, and then, those of two hands with each other. The winner or loser of the game is determined only when either of at least one of the players and the banker has won at both of the above hands. There are procedures for dividing dealt-cards 72 into two groups, and the players must win at both of the above hands. Therefore, the players are required to adopt a strategy different from those of other poker games, which becomes a kind of amusing attractiveness of the game.

In addition, a game machine exists which is capable of accepting a side BET different from a normal BET. For example, in blackjack, in a case where one of the dealer's two cards, for example, a card “A” is faced up, the players can perform a side BET called “Insurance” in addition to a normal BET. In a case where “Insurance” is performed, the players can additionally make a first bet at half price. In a case where the dealer's hand is “Natural 21”, the amount of bet, which is twice of the side BET (insurance), is paid back.

In the Caribbean Stud poker, for example, a side BET is accumulatively stored as a progressive jackpot. The players can acquire all or part of the progressive jackpots in accordance with an established hand when performing a side BET in addition to an ante (a normal BET). Games for accepting the side BET are disclosed in U.S. Pat. Nos. 6,789,801, 5,711,525, and 6,874,786, for example.

However, in the conventional game machine, dealt cards per se never vary partway. Thus, players can predict what kind of combination is realized to some extent, since a game is conducted in consideration of only the dealt cards. On the other hand, where a combination of the dealt cards is out of the player's anticipation, an unfavorable outcome of the game can also be predicted. Thus, there has been a possibility that the player's anticipation to the game is lowered at the time point at which the originally dealt card 72 is visually recognized. Therefore, a need exists for the advent of new methods of playing card games and game machines with new entertainment.

The present invention has been made in view of the above-described circumstance. It is an object of a card game playing method and game machine, having new entertainability.

### SUMMARY OF THE INVENTION

A first aspect of the present invention is a method of playing card games, including the steps of: (a) dealing a predetermined number of cards as player's cards and dealing a predetermined number of cards as banker's cards from among plural types of cards; (b) varying a predetermined card included in the player's cards to another kind of card at a predetermined timing in a case where the player's cards include the predetermined card for a duration from dealing of cards to an end of a game in the step (a); and (c) determining a winner or a loser by comparing hands of the player's cards with hands of the banker's cards.

According to the present invention, the card game playing method, with new entertainability, can be provided, in which in a case where the dealt cards of a player's hand include a predetermined card, for example, a joker, a player can anticipate that the joker is unexpectedly varied in the course of a game, and, in addition to the first dealt cards, the player can enhance anticipation for the subsequent progress of a game, for example, anticipation for the progress that a higher combination of cards might be realized.

A second aspect of the present invention is the card game playing method of the first aspect of the invention, wherein the step (b) includes the step of varying the predetermined card included in the player's cards to another kind of card in a case where an input is made from an input device for accepting the player's operation.

According to the present invention, for example, the player is given an opportunity of selecting a combination so that the joker is varied to another card by performing an operation of making a selection, and then, a higher combination of cards can be obtained in the case where the dealt cards include a predetermined card, for example, a joker. Therefore, the card game playing method, with entertainability, can be provided which allows the player to enhance anticipation that a higher combination might be realized.

A third aspect of the present invention is the card game playing method of the first aspect of the invention, wherein the step (b) includes the step of varying the predetermined card included in the player's cards to a card inclusive of a symbol for paying a special bonus.

According to the present invention, the card game playing method, with new entertainability, can be provided in which the player is allowed to have anticipation that, in addition to payout in a base game, another special bonus, for example, a large amount of jackpot payout can be received at the same time.

A fourth aspect of the present invention is a method of playing card games, including the steps of: (a) dealing a predetermined number of cards as player's cards and dealing a predetermined number of cards as banker's cards from among plural kinds of cards; (b) varying a predetermined card included in the player's cards to another kind of card at a predetermined timing for a duration from dealing of cards to an end of a game in the step (a) in a case where the player's cards include the predetermined card and in a case where an input is made from an input device for accepting the player's operation; and (c) determining a winner or a loser by comparing hands of the player's cards and hands of the banker's cards.

A fifth aspect of the present invention is the card game playing method of the fourth aspect of the invention, wherein the step (b) includes the step of varying the predetermined card included in the player's cards to a card inclusive of a symbol for paying a special bonus.

A sixth aspect of the present invention is a method of playing card games, including the steps of: (a) dealing a predetermined number of cards as player's cards and dealing a predetermined number of cards as banker's cards from among plural types of cards; (b) dividing the predetermined number of player's cards into two groups of cards; (c) dividing the predetermined number of banker's cards into two groups of cards; (d) varying the predetermined card included in the player's cards to another type of card at a predetermined timing in a case where the player's cards divided into the two groups include the predetermined card for a duration from dealing of cards to an end of a game in the step (a); and (e) determining a winner or a loser by comparing hands of the player's cards divided into the two groups with hands of the banker's cards divided into the two groups.

A seventh aspect of the present invention is the card game playing method of the sixth aspect of the invention, the step (d) includes the step of varying the predetermined card included in the player's cards to another kind of card in a case where an input is made from an input device for accepting the player's operation.

An eighth aspect of the present invention is the card game playing method of the sixth aspect of the invention, wherein the step (d) includes the step of varying the predetermined card included in the player's cards to a card inclusive of a symbol for paying a special bonus.

A ninth aspect of the present invention is a method of playing card games, including the steps of: (a) dealing a predetermined number of cards as player's cards and dealing a predetermined number of cards as banker's cards from among plural types of cards; (b) dividing the predetermined number of player's cards into two groups of cards; (c) dividing the predetermined number of banker's cards into two groups of cards; (d) varying a predetermined card included in the player's cards to another kind of card at a predetermined timing for a duration from dealing of cards to an end of a game in the step (a) in a case where the player's cards include the predetermined card and in a case where an input is made from an input device for accepting the player's operation; and (e) determining a winner or a loser by comparing hands of the player's cards divided into the two groups with hands of the banker's cards divided into the two groups.

A tenth aspect of the present invention is a game machine, including the step (d) includes the step of varying the predetermined card included in the player's cards to a card inclusive of a symbol for paying a special bonus.

An eleventh aspect of the present invention is a game machine, including a display device for displaying plural kinds of cards; an input device for accepting a player's operation; a memory for storing variation video data for varying a predetermined card of plural kinds of cards to another kind of card; and a processor for controlling the display device, the input device, and the memory, the processor being programmed to execute processing operations of: (a) displaying a predetermined number of player's cards and a predetermined number of banker's cards on the display device; (b) varying a predetermined card included in the player's cards to another kind of card at a predetermined timing, based upon the variation video data stored in the memory, in a case where the player's cards include the predetermined card for a duration from dealing of cards to an end of a game in the process (a); and (c) determining a winner or a loser by comparing hands of the player's cards with hands of the banker's cards, the cards being divided into the two groups.

According to the present invention, the game machine with new entertainability can be provided, in which in a case where the dealt cards of a player include a predetermined card, for example, a joker, a player can anticipate that the joker unexpectedly is varied in a game, and, in addition to the first dealt cards, the player can enhance anticipation associated with the subsequent progress of a game, for example, anticipation that a higher combination of cards might be realized.

A twelfth aspect of the present invention is the game machine of the eleventh aspect of the invention, wherein the processor varies the predetermined card included in the player's cards to another kind of card, based upon the variation video data stored in the memory in a case where an input is made from the input device in the process (b).

According to the present invention, the game machine, with entertainability, can be provided in which, for example, the player is given a opportunity of selecting a combination so that the joker is varied to another card by performing an operation of making a selection, and then, a higher combination of cards can be obtained in the case where the dealt cards include a predetermined card, for example, a joker. Therefore, the game machine, with entertainability, can be provided which allows the player to enhance anticipation that a higher combination might be realized.

A thirteenth aspect of the present invention is the game machine of the eleventh or twelfth aspect of the invention, wherein the processor varies the predetermined card included in the player's cards to a card inclusive of a symbol for paying a special bonus in the process (b).

According to the present invention, the game machine with new entertainability can be provided in which the player is allowed to have anticipation that, in addition to payout in a base game, another special bonus, for example, a large amount of jackpot payout can be received at the same time.

A fourteenth aspect of the present invention is a game machine, including: a display device for displaying plural kinds of cards; an input device for accepting a player's operation; a memory for storing variation video data for varying a predetermined card of plural kinds of cards to another kind of card; and a processor for controlling the display device, the input device, and the memory, the processor being programmed to execute processing operations of: (a) displaying a predetermined number of player's cards and a predetermined number of banker's cards on the display device; (b) varying a predetermined card included in the player's cards to another kind of card at a predetermined timing, based upon the variation video data stored in the memory, in a case where the player's cards include the predetermined card and in a case where an input is made from the input device for a duration from dealing of cards to an end of a game in (a); and (c) determining a winner or a loser by comparing hands of the player's cards with hands of the banker's cards.

A fifteenth aspect of the present invention is the game machine of the fourteenth aspect of the invention, wherein the processor varies the predetermined card included in the player's cards to a card inclusive of a symbol for paying a special bonus in the process (b).

A sixteenth aspect of the present invention is a game machine, including: a display device for displaying plural kinds of cards; an input device for accepting a player's operation; a memory for storing variation video data for varying a predetermined card of plural kinds of cards to another kind of card; and a processor for controlling the display device, the input device, and the memory, the processor being programmed to execute processing operations of: (a) displaying a predetermined number of player's cards and a predetermined number of banker's cards on the display device; (b) varying a predetermined card included in the player's cards to a card inclusive of a symbol for paying a special bonus at a predetermined timing, based upon the variation video data stored in the memory, in a case where the player's cards include the predetermined card and in a case where an input is made from the input device for a duration from dealing of cards to an end of a game in the process (a); and (c) determining a winner or a loser by comparing hands of the player's cards with hands of the banker's cards, the cards being divided into the two groups.

A seventeenth aspect of the present invention is a game machine, including: a display device for displaying plural kinds of cards; an input device for accepting a player's operation; a memory for storing variation video data for varying a predetermined card of plural kinds of cards to another kind of card; and a processor for controlling the display device, the input device, and the memory, the processor being programmed to execute processing operations of: (a) displaying a predetermined number of player's cards and a predetermined number of banker's cards on the display device; (b) dividing the predetermined number of player's cards into two groups of cards; (c) dividing the predetermined number of banker's cards into two groups of cards; (d) varying a predetermined card included in the player's cards to another kind of card at a predetermined timing for a duration from dealing of cards to an end of a game in the process (a), based upon the variation video data stored in the memory, in a case where the player's cards include the predetermined card; and (e) determining a winner or a loser by comparing hands of the player's cards divided into the two groups with hands of the banker's cards divided into the two groups.

An eighteenth aspect of the present invention is the game machine of the seventeenth aspect of the invention, wherein the processor varies the predetermined card to another kind of card, based upon the variation video data stored in the memory in a case where an input is made from the input device in the process (d).

An nineteenth aspect of the present invention is the game machine of the seventh aspect of the invention, wherein the processor varies the predetermined card to another kind of card, based upon the variation video data stored in the memory in a case where an input is made from the input device in the process (d).

A twentieth aspect of the present invention is a game machine, including a display device for displaying plural kinds of cards; an input device for accepting a player's operation; a memory for storing variation video data for varying a predetermined card of plural kinds of cards to another kind of card; and a processor for controlling the display device, the input device, and the memory, the processor being programmed to execute processing operations of: (a) displaying a predetermined number of player's cards and a predetermined number of banker's cards on the display device; (b) dividing the predetermined number of player's cards into two groups of cards; (c) dividing the predetermined number of banker's cards into two groups of cards; (d) varying a predetermined card included in the player's cards to a card inclusive of a symbol for paying a special bonus at a predetermined timing, based upon the variation video data stored in the memory, in a case where the player's cards include the predetermined card for a duration from dealing of cards to an end of a game in (a) and in a case where an input is made from an input device for accepting the player's operation; and (e) determining a winner or a loser by comparing hands of the player's cards divided into the two groups with hands of the banker's cards divided into the two groups.

A twenty first aspect of the present invention is the game machine of the twentieth aspect of the invention, wherein the processor varies the predetermined card included in the player's cards to a card inclusive of a symbol for paying a special bonus in the process (d).

A twenty second aspect of the present invention is a game machine, including a display device for displaying plural kinds of cards; an input device for accepting a player's operation; a memory for storing variation video data for varying a predetermined card of plural kinds of cards to another kind of card; and a processor for controlling the display device, the input device, and the memory, the processor being programmed to execute processing operations of: (a) displaying a predetermined number of player's cards and a predetermined number of banker's cards on the display device; (b) dividing the predetermined number of player's cards into two groups of cards; (c) dividing the predetermined number of banker's cards into two groups of cards; (d) varying a predetermined card included in the player's cards to a card inclusive of a symbol for paying a special bonus at a predetermined timing for a duration from dealing of cards to an end of a game in the process (a), based upon the variation video data stored in the memory, in a case where the player's cards include the predetermined card and in a case where an input is made from an input device for accepting the player's operation; and (e) determining a winner or a loser by comparing hands of the player's cards divided into the two groups with hands of the banker's cards divided into the two groups.

### BRIEF DESCRIPTION OF THE DRAWINGS

FIG. 1A is a view showing an exemplary image displayed on a liquid crystal display 10 included in each of stations 3 according to a first embodiment;

FIG. 1B is a view showing an exemplary image displayed on the liquid crystal display included in each of the stations according to the first embodiment;

FIG. 2 is a perspective view schematically illustrating an appearance and an configuration of a game machine according to the first embodiment;

FIG. 3 is a perspective view schematically illustrating an appearance and an configuration of each of the stations included in the game machine according to the first embodiment;

FIG. 4 is a view showing an exemplary image displayed on a front panel display device included in the game machine according to the first embodiment;

FIG. 5 is a view showing an exemplary image displayed on a liquid crystal display included in the game machine according to the first embodiment;

FIG. 6 is a block diagram depicting an internal configuration of the game machine shown in FIG. 2;

FIG. 7 is a block diagram depicting an internal configuration of each of the stations included in the game machine shown in FIG. 2;

FIG. 8A is a view showing an exemplary image displayed on the liquid crystal display included in each of the stations according to the first embodiment;

FIG. 8B is a view showing an exemplary image displayed on the liquid crystal display included in each of the stations according to the first embodiment;

FIG. 9A is a view showing an exemplary image displayed on the liquid crystal display included in each of the stations according to the first embodiment;

FIG. 9B is a view showing an exemplary image displayed on the liquid crystal display included in each of the stations according to the first embodiment;

FIG. 10A is a view showing an exemplary image displayed on the liquid crystal display included in each of the stations according to the first embodiment;

FIG. 10B is a view showing an exemplary image displayed on the liquid crystal display included in each of the stations according to the first embodiment;

FIG. 11A is a flowchart showing main control unit processing executed at a main control unit included in the game machine according to the first embodiment;

FIG. 11B is a flowchart showing main control unit processing executed at a main control unit included in the game machine according to the first embodiment;

FIG. 12A is a flowchart showing a subroutine of station processing executed in each of the stations according to the first embodiment;

FIG. 12B is a flowchart showing a subroutine of station processing executed in each of the stations according to the first embodiment;

FIG. 12A is a flowchart showing a subroutine of station processing executed in each of the stations according to the second embodiment; and

FIG. 12B is a flowchart showing a subroutine of station processing executed in each of the stations according to the first embodiment.

### DESCRIPTION OF THE PREFERRED EMBODIMENTS

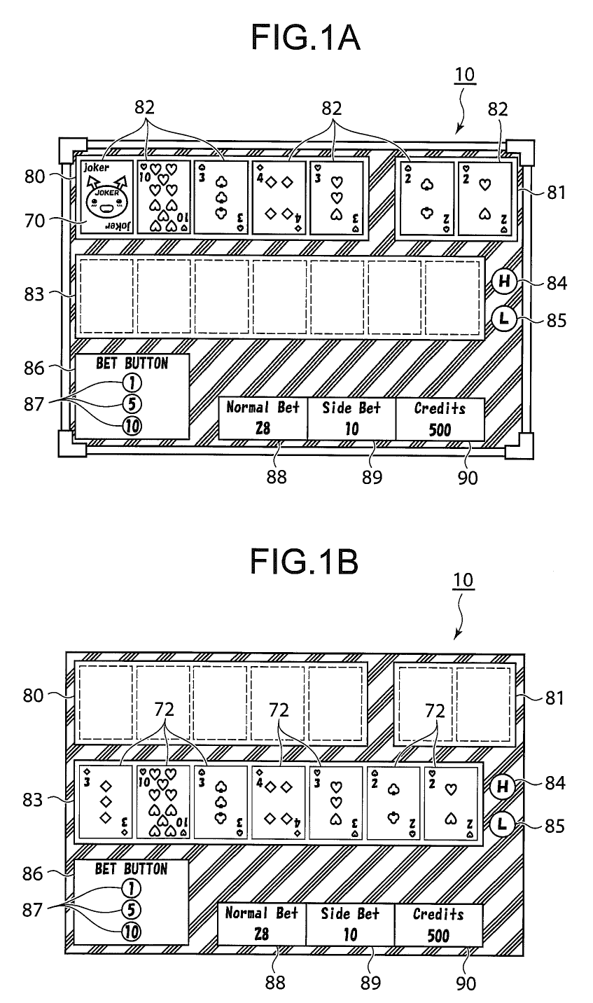

A game machine according to the present invention will be described in detail with referring to the drawings. First, referring to FIGS. 1A and 1B, essential parts of the present invention will be described in detail. Here, players and a banker perform a method of playing card games. These figures are views each showing an exemplary game image displayed on the liquid crystal display included in each of the stations.

In the present invention, in a game, from among plural kinds of cards, a predetermined number of players' cards are dealt to players, and a predetermined number of the banker's cards are dealt to the banker. From the dealing of cards to the end of the game, if the player's cards include a predetermined card (for example, a joker), that card is varied to another kind of card at a predetermined timing. Then, a winner or loser is determined by comparing hands of the players' cards with those of the banker's cards.

Subsequently, the embodiments that follow describe in detail a case in which the PAIGOW poker is performed, and then, a joker 70 of the cards dealt to the player is varied to another predetermined card or a trigger for giving a payment.

First, the rules of the PAIGOW poker will be described in detail. In the PAIGOW poker of the present embodiment, one or more players complete against a banker with the use of one set of 52 trump cards (playing cards) excluding a joker.

Seven cards are dealt to each of the persons consisting of a banker and the players. Each of them divides seven cards into two groups of five cards and of two cards. At this time, a hand of five cards (a high hand) must be as strong as or must be stronger than that of two cards (a low hand).

Next, it is judged as to which one of the players' hands is strong or weak after comparing the five cards of each of the banker's and players' hands with each other. Similarly, it is judged as to which one of the players' hands is strong or weak after comparing the two cards of each of the banker's and players' hands with each other. In a case where the banker's hands are stronger in both of the two groups of five and two cards, it is judged to be the banker's win. In a case where one of the players' hands is stronger in both of the two groups of five and two cards, it is judged to be the player's win. In a case where the player's hands are stronger in one of the two groups consisting of five cards and two cards, and the banker's hand is stronger in the other one, it is judged to be “draw”. In addition, in a case where the player's hand and the banker's hand are identical to each other in strength with respect to both of the two groups of five and two cards, it is judged to be the banker's win.

The hands of five cards include “Royal Flush”, “Straight Flush”, “Four of a Kind”, “Full House”, “Straight”, “Three of a Kind”, “Two of a Kind”, and “No Pair” in order of strength. The hands of two cards include “One Pair” and “No Pair” in order of strength.

In addition, in a case where the player's and banker's hands are identical to each other, it is judged as to which one of the players' hands is strong or weak after comparing the numbers or alphabets drawn in cards constituting the hands with each other. The card's numbers and alphabets include “A”, “K”, “Q”, “J”, “10”, “9”, “8”, “7”, “6”, “5”, “4”, “3”, and “2” in sequential order from the strongest combination of the five cards.

In the embodiments that follow, the PAIGOW poker, which accepts a normal BET and a side BET, is executed. The normal BET is to be performed as to a win or loss of the PAIGOW poker in a game in which the joker 70 might be varied when the joker 70 has been dealt. Alternatively, if the joker 70 is at hand, video data indicative of variation of the joker 70 may be selected on condition that the side BET is performed. Among the betted or side-betted currency values, a predetermined rate is accumulatively stored as a jackpot (hereinafter, referred to as a JP). The first embodiment describes a case in which a dealer takes over the banker.

FIG. 1A shows an exemplary PAIGOW poker. First, from among plural kinds of cards, seven player's cards 72 (in predetermined number) are dealt to each of the players, and seven banker's cards are dealt to the banker.

Next, the player divides the dealt player's cards 72 into two groups of cards. As shown in FIG. 1A, the player divides the player's cards into a group of five cards of a high hand and that of two cards of a low hand. Similarly, the banker divides the dealt banker's cards into these two groups of cards, five cards of a high hand and two cards of a low hand. In this case, for a duration from dealing of the cards to the end of the game the player's cards divided into the two groups include the “joker” card 71 (a predetermined card). Thus, this joker card is varied to a card 71 of “3 of Diamond” (another kind of card) at a predetermined timing.

As shown in FIG. 1B, the players are given an opportunity of selecting cards again. In this case, a combination “three of a kind”, which is higher than that of the first selected card, is realized, thus making it possible to select the combination “three of a kind” at a high hand and a combination “two pairs” at a low hand. Then, a winner or loser is determined by comparing the hands (high and low hands) of the player's cards divided into two groups with those of the banker's cards. The predetermined timing may be determined when a side BET is performed. Further, the above-mentioned “joker” card 71 may be varied to a symbol for paying a special bonus.

### <Description of Appearance of the Game Machine>

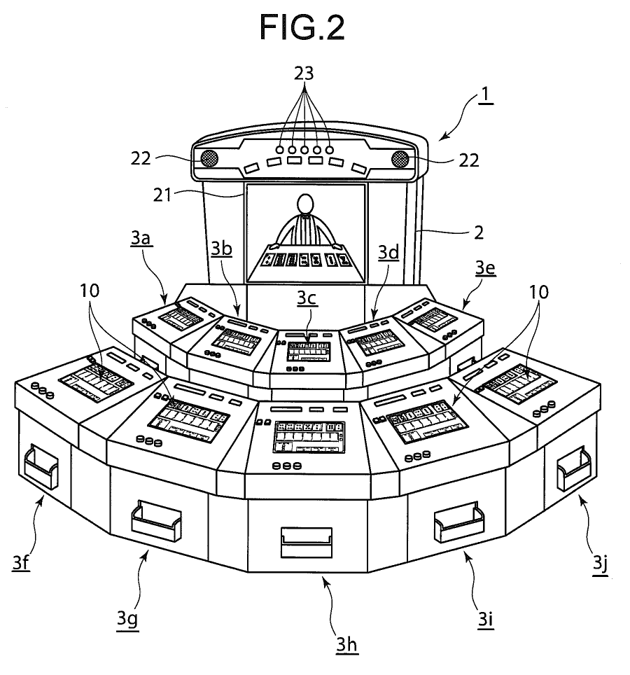

Next, referring to FIG. 2, the game machine 1 according to the first embodiment will be described. FIG. 2 is a perspective view schematically illustrating an appearance and a configuration of the game machine 1 according to the first embodiment.

As shown in FIG. 2, the game machine 1 is basically made up of a main monitor 2 and five stations 3 (stations 3a to 3e). While the first embodiment describes in detail a case in which the game machine 1 is provided with a plurality of stations 3 (five stations), the game machine, in the present invention, may include five or more stations.

A front panel display 21 is provided at the center of the main monitor 2, and displays images of a dealer and plural kinds of cards. In the embodiments of the present invention, the front panel display 21 is equivalent to a display device. At the upper side of the main monitor 2, further, a speaker 22, which outputs music or effect sounds in accordance with the progress of games executed by the game machine 1; and an LED23 lit up at the time of various effects are provided.

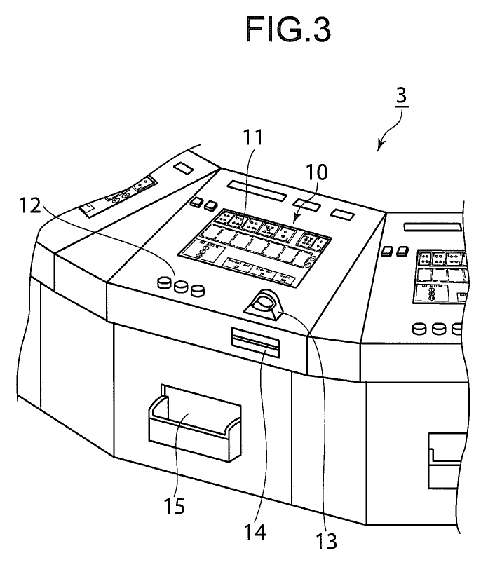

Referring to FIG. 3, an appearance and a configuration of stations 3 that are included in the game machine 1 will be described in detail. FIG. 3 is a perspective view schematically illustrating an appearance and a configuration of stations 3 included in the game machine 1 shown in FIG. 2. As illustrated in FIG. 3, a liquid crystal display 10, which displays images pertinent to operation (for example, plural kinds of cards), is provided at the upper center of each of the stations 3. In the embodiment of the present invention, the liquid crystal display 10 is equivalent to a display device. Further, a touch panel 10 for inputting operations such as BET is provided on the top face of the liquid crystal display 10. In the embodiment of the present invention, the station 3 is equivalent to an input device for accepting the player's operation.

An operational button 12 for making payout operation and a coin insertion slot 13 for inserting coins or medals are provided in front of the liquid crystal display 10. A bill insertion slot 14 for inserting bills is provided at the front top right end of the station 3. Provided downwardly of the bill insertion slot 14 is a coin payout opening 15 through which the coins or medals corresponding to stored credit are paid out to the players when a payout operation is made.

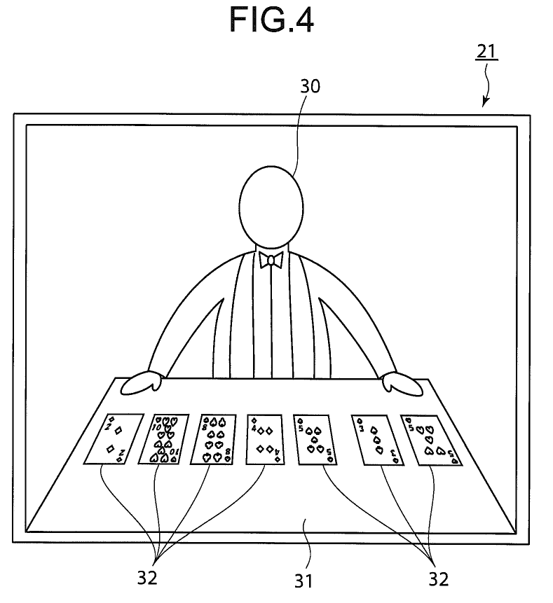

Referring now to FIG. 4, an image displayed on the front panel display 21 will be described in detail. FIG. 4 is a view showing an exemplary image displayed on a front panel display included in a game machine. As shown in FIG. 4, the front panel display 21 serves to display a dealer image 30 indicative of a dealer (banker), a table image 31 indicative of a table, and a card image 32 indicative of seven banker's cards. The card image 32 is displayed in a faced down manner when cards are dealt to the dealer. When high and low hands are determined, the card image 32 is displayed in a faced up manner. In FIG. 4, the left five cards toward the dealer indicate a high hand, and the right two cards indicate a low hand.

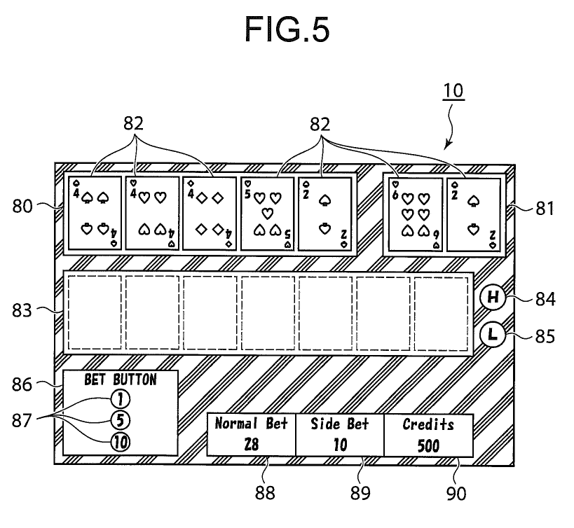

Next, referring to FIG. 5, an image displayed on the liquid crystal display 10 will be described in detail. FIG. 5 is a view showing an exemplary image displayed on the liquid crystal display 10 included in the station 3.

As shown in FIG. 5, a high hand display section 80, which displays a player's high hand, and a low hand display section 81, which displays a low hand, are provided at the upper side of the liquid crystal display 10. The high hand display section 80 and the low hand display section 81 serve to display card images 82 indicative of a high hand card and a low hand card, respectively, in a faced up manner. The liquid crystal display 10 is equivalent to a display device in the first embodiment.

A dealt-card display section 83 is provided at the lower side of the high hand display section 80. A card image indicative of the seven player's cards dealt to each of the players is displayed in a faced up manner at seven portions enclosed by the dotted line of the dealt-card display section 83. A high hand determination button 84 and a low hand determination button 85, for determining cards constituting a high hand and a low hand, are provided at the right side of the dealt-card display section 83. A player can determine a high hand by selecting a card desired to be high hand, via a touch panel 11, from among the cards displayed at the dealt-card display section 83, and then, operating the high hand determination button 84. The card determined to be a high hand is displayed at the high hand display section 80. Similarly, the player determines a low hand by selecting a card desired to be a low hand, via the touch panel 11, from among the cards displayed at the dealt-card display section 83, followed by operating a low hand determination button 85 via the touch panel 11.

A BET button display section 86 is provided at the lower side of the dealt-card display section 83. The BET button display section 86 serves to display a BET button 87 for inputting a BET number. The player can input a normal BET number and a side BET number by operating a BET button 87 via the touch panel 11.

A normal BET number display section 88, which displays the number of normally betted coins, is provided at the right side of the BET button display section 86. In FIG. 5, it is shown that 28 coins have been betted. In a case where betting of these 28 coins is input, the player may operate “10” of the BET button 87 twice, “5” of the BET button 87 once, and “1” of the BET button 87 three times.

A side BET number display section 89, which displays the number of side-betted coins, is provided at the right side of a normal BET number display section 88. In FIG. 5, it is shown that 10 coins have been betted. A credit number display section 90 is provided at the right side of the side BET number display section 89. In the figure, it is shown that 500 coins have been credited.

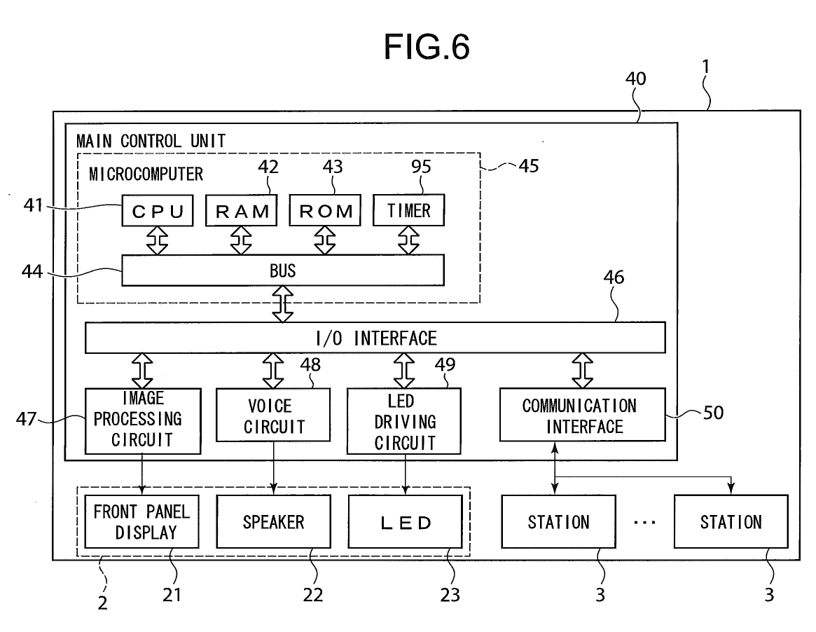

FIG. 6 is a block diagram depicting an internal configuration of the game machine shown in FIG. 2. As shown in the figure, the game machine 1 is provided with the main monitor 2 and stations 3 (input devices). The main control unit 40 is provided with a microcomputer 45, an I/O interface, an image processing circuit 47, a voice circuit 48, an LED driving circuit 49, and a communication interface 50. The main monitor 2 is provided with the front panel display 21, the speaker 22, and the LED23.

The microcomputer 45 included in the main control unit 40 is provided with a CPU41 (processor), a RAM42 (memory), a ROM43 (memory), a bus 44, and a timer 95. This game machine is basically constituted while the microcomputer 45 made up of the CPU41, the RAM42, the ROM43, the timer 95, and the bus 44 for transferring data therebetween is employed as a base.

The CPU41 (processor) controls the devices connected to the game machine 1, such as the front panel display 21, the stations 3 (input devices), the RAM42 (memory), and the ROM43 (memory). The CPU41 is connected via the I/O interface 46 to the image processing circuit 47, the voice circuit 48, the LED driving circuit 49, and the communication interface 50.

The CPU41 controls: game programs stored in the ROM43 (memory) (including a PAIGOW poker game program, a side-game program, variation video data for varying a predetermined card of plural kinds of cards to another kind of card, and a data table of the above data); and a game (PAIGOW poker) conducted in the game machine 1. This controlling operation is performed based upon various signals received from the station 3. For example, there is a program which causes a computer to execute processing of varying the predetermined card included in the player's cards to another kind of card at a predetermined timing. This processing operation is performed based upon the variation video data stored in the RAM in a case where the predetermined card is included in the player's cards from the display of cards to the end of the game. Further, the CPU41 controls the front panel display 21 to display an image, the speaker 22 to output sounds, and the LED23 to light up. This controlling operation is performed based upon the above-mentioned game programs. Furthermore, the CPU41 transmits various signals to stations 3, based upon the game programs. In the first embodiment, the CPU41 is equivalent to a processor for controlling a display device, an input device, and a memory.

The RAM42 is a memory for temporarily storing various data computed by the CPU41. The stored data includes various items of information such as: BET information; side-BET information; credit information; side-BET flag information; card information for a joker 70; variation video data; and jackpot information. In the first embodiment, the RAM42 is equivalent to a memory for storing variation video data for varying a predetermined card of plural kinds of cards to another kind of card.

The ROM43 stores various programs for performing required processing for controlling the game machine 1 and a data table. The data table includes, for example, a variation video data table.

The bus 44 is connected to the CPU41, the RAM42, the ROM43, the timer 95, and the I/O interface. The information contained in the microcomputer is moved via the bus 44. The timer 95 serves to perform clock measurement.

The I/O interface 46 included in the main control unit is connected to the bus 44, the image processing circuit 47, the voice circuit 48, the LED driving circuit 49, and the communication interface 50.

The front panel display 21 constituting the main monitor 2 is connected to the image processing circuit 47; the speaker 22 constituting the main monitor 2 is connected to the voice circuit 48; and the LED23 constituting the main monitor 2 is connected to the LED driving circuit 49. One or more stations 3 are connected to the communication interface 50. Although FIG. 2 shows that five stations are connected as an example, one station or seven stations may be connected.

The display device 2 included in the game machine 1 is provided with the front panel display 21, the speaker 22, and the LED23. The CPU41 controls the front panel display to display an image via the bus 44 and the I/O interface 46, the speaker 22 to output sounds from the speaker 22, and the LED23 to light up. This controlling operation is performed based upon the above-mentioned game programs.

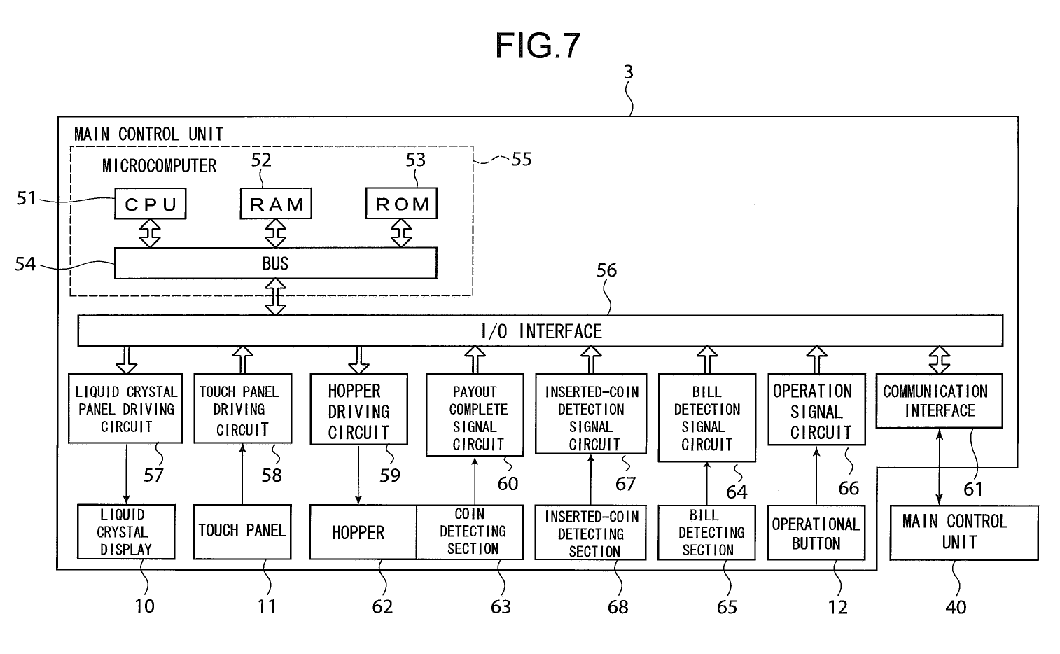

Next, referring to FIG. 7, an internal configuration of each of the stations 3 will be described in detail. FIG. 7 is a block diagram depicting the internal configuration of each of the stations 3 included in the game machine 1 shown in FIG. 2. As shown in FIG. 7, each of the stations 3 is provided with: a microcomputer 55; a liquid crystal panel driving circuit 57; a liquid crystal display 10; a touch panel driving circuit 58; a touch panel 11; a hopper driving circuit 59; a hopper 62; a payout complete signal circuit 60; a coin detecting section 63; an inserted-coin detection signal circuit 67; an inserted-coin detecting section 68; a bill detection signal circuit 64; a bill detecting section 65; an operation signal circuit 66; operational buttons 12; and a communication interface 61. Further, the station 3 is constituted while the microcomputer 55 made up of the CPU51, the RAM52, the ROM63, and the bus 54 for transferring data therebetween is employed as a base.

The CPU51 included in the microcomputer 55 is connected via the bus 54 and the I/O interface 56 to a liquid crystal panel driving circuit 57, a touch panel driving circuit 58, a hopper driving circuit 59, a payout complete signal circuit 60, an inserted-coin detection signal circuit 67, a bill detection signal circuit 64, an operational signal circuit 66, and a communication interface 61. Further, the CPU51 conducts a game (PAIGOW poker) at the station 3, based upon the game programs (including a PAIGOW poker game program) stored in the ROM43 and various signals received from the main control unit 40. Furthermore, the CPU51 controls the liquid crystal display 10 to display an image, based upon the above-mentioned game programs, and then, transmits the various signals to the stations 3, based upon the above-mentioned game programs.

The RAM52 is a memory for temporarily storing the various data computed by the CPU51. The stored data includes various items of information such as: BET information; side-BET information; credit information; side-BET flag information; card information for a joker 70; variation video data; and jackpot information. In the first embodiment, the CPU51 is equivalent to a processor for controlling a display device, an input device, and a memory.

The ROM53 stores various programs for the CPU51 to perform required processing for controlling stations 3 and a data table. The data table includes a variation video data table.

The liquid crystal display 10 is connected to the liquid crystal display panel driving circuit 57 connected to the I/O interface 56. The touch panel 11 is connected to the touch panel driving circuit 58. The hopper 62 is connected to the hopper driving circuit 59. The coin detecting section 63 is connected to the payout complete signal circuit 60. The inserted-coin detecting section 68 is connected to the inserted-coin detection signal circuit 67. The bill detecting section 65 is connected to a bill sampling signal circuit 64, and operational buttons 12 are connected to the operational signal circuit 66, respectively.

The liquid crystal display 10 is for displaying a game screen, for example, plural kinds of cards dealt to the player. In the first embodiment, the liquid crystal display 10 is equivalent to a display device. The touch panel 11 is for accepting the player's operation, for example, a selection operation.

The hopper 62 is provided inside the station 3, and pays out coins from a coin payout opening 15, based upon a control signal outputted from the CPU51. The coin detecting section 63 is provided inside the coin payout opening 15, and transmits signals to the CPU51 in the case of detecting that a predetermined number of coins have been paid out from the coin payout opening 15.

Upon detecting that coins have been inserted through the coin insertion slot 13, the inserted-coin detecting section 68 detects the amount of the detected coins, and then, transmits to the CPU51 a detection signal indicative of the detected amount. The detected coins are stored in the RAM52 while a predetermined amount is handled as one credit.

At the time of acceptance of bills, the bill detecting section 65 detects the amount of the accepted bills, and then, transmits to the CPU51 a detection signal indicative of the detected amount. The detected bills are stored in the RAM52 while the predetermined amount is handled as one credit. The operation button 12 is intended for performing payout operation in a case where coin payout has been determined.

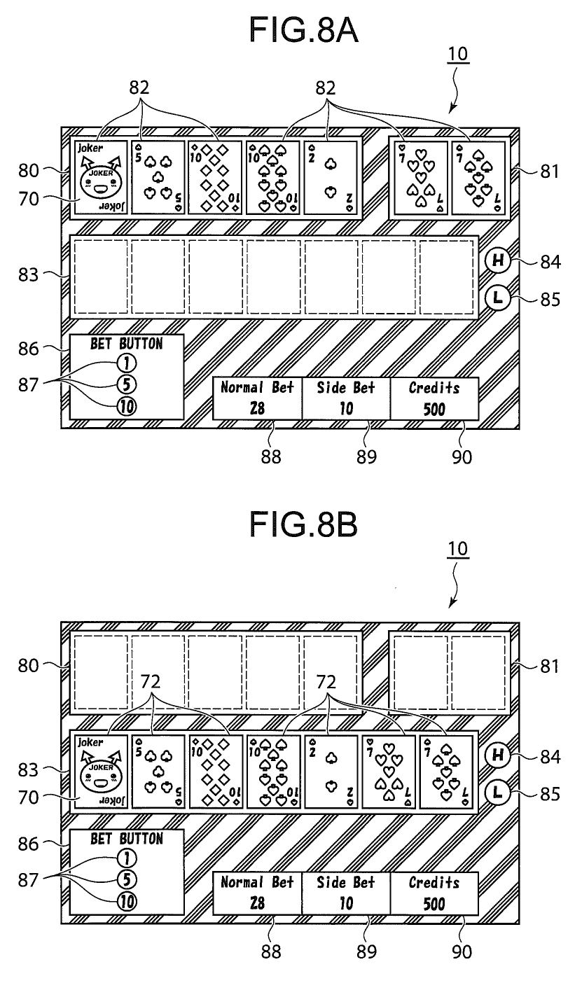

Next, referring to FIGS. 8A and 8B, an exemplary case in which a player actually performs a game will be described in detail. FIGS. 8A and 8B are views each showing an exemplary game screen displayed on the screen of the liquid crystal display 10 of the game machine 1. As shown in FIG. 8A, when a game is started, at first, the cards 72 dealt to the player are displayed at a dealt-card display section 83. Then, the player selects cards via the touch panel 11 (input device), and the selected high hand is displayed at a high hand display section 80, and the selected low hand is displayed at a low hand display section 81. In this case, from among seven cards after displayed (“K of clover”, “7 of clover”, “joker 70”, “7 of diamond”, “7 of spade”, “5 of clover”, and “5 of heart”), the player selects five cards (“K of clover”, “7 of clover”, “joker 70”, “7 of diamond”, “7 of spade”) at high hand and two cards (“5 of clover”, and “5 of heart”) at low hand. At the lower side of the dealt-card display 72, a normal BET number display section 88; a side-BET number display section 89, which displays the number of side-betted coins; and a credit amount display section 90 are provided. In this case, 28 coins are normally betted, 10 coins are side-betted, and 500 coins are credited. However, the joker 70 is kept unchanged as it is (FIG. 8B). The role of the “joker 70” is handled as A (Ace) with no suit.

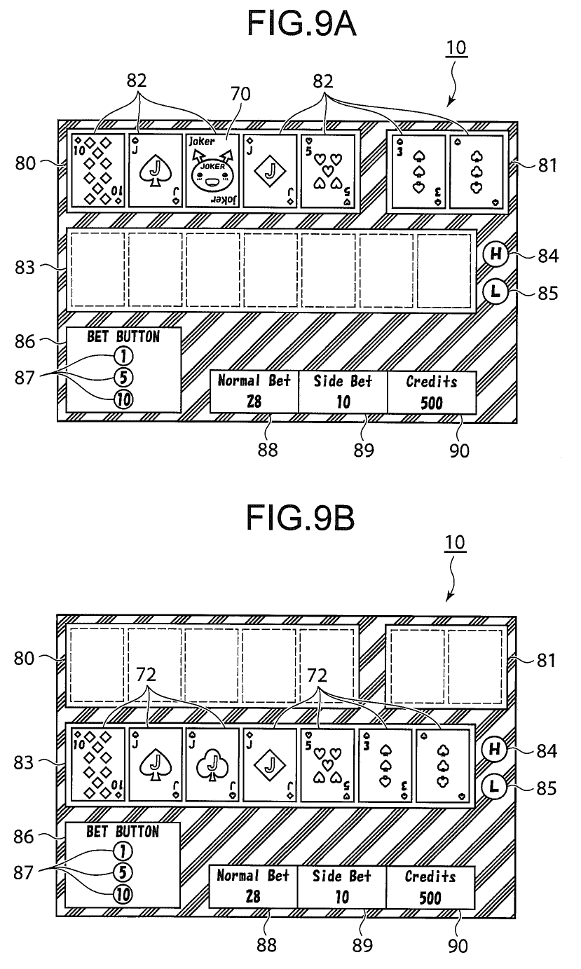

Next, referring to FIGS. 9A and 9B, another exemplary screen of a game actually performed will be described in detail. FIGS. 9A and 9B are views each showing an exemplary image displayed on the liquid crystal display 10 of each of the stations 3 in the game machine 1 according to the first embodiment. As shown in FIG. 9A, at first, the cards dealt to the player 72 is displayed at the dealt-card display section 83, and then, the player selects cards via the touch panel 11 (input device). The selected high hand is displayed at the high hand display section 80 and the selected low hand is displayed at the low hand display section 81. From among the seven cards after displayed (“10 of diamond”, “J of spade”, “joker 70”, “J of diamond”, “5 of heart”, “3 of spade”, and “3 of clover”), the player selects five cards (“10 of diamond”, “J of spade”, “joker 70”, “J of diamond”, and “5 of heart”) at high hand and two cards (“3 of spade”, and “3 of clover”) at low hand. At the lower side of the dealt-card display 72, further, a normal BET number display section 88; a side-BET number display section 89, which displays the number of side-betted coins; and a credit amount display section 90 are provided. In this case, 28 coins are normally betted, 10 coins are side-betted, and then, 500 coins are credited.

After that, the joker 70 is varied to J of clover (FIG. 9A). In general, the role of the joker 70 is handled as A (Ace) with no suit. As mentioned above, however, the “joker 70” is varied to “J of clover”. If the player selects “10 of diamond”, “J of spade”, “joker 70”, “J of diamond”, and “5 of heart” at high hand and “3 of spade” and “3 of clover”, a combination “three of a kind” is realized at high hand (FIG. 9).

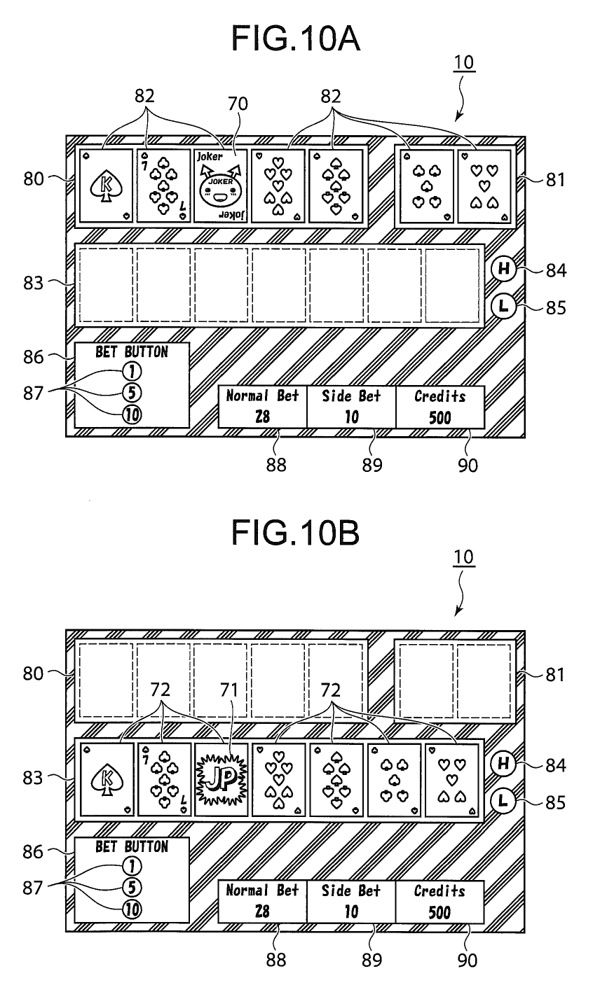

Next, referring to FIGS. 10A and 10B, another example of an actual game screen will be described in detail. FIG. 10A and FIG. 10B are views each showing an exemplary image displayed on the liquid crystal display 10 of each of the stations 3 in the game machine 1 according to the first embodiment. In this example, the player's hands are seven cards (“10 of diamond”, “J of spade”, “joker 70”, “J of diamond”, “5 of heart”, “3 of spade”, and “3 of clover”) displayed at the dealt-card display section 83 of FIG. 10B. The player selects five cards (“10 of diamond”, “J of spade”, “joker 70”, “J of diamond”, and “5 of heart”) at high hand and two cards (“3 of spade”, and “3 of clover”) at low hand. At the lower side of the dealt-card display 72, further, a normal BET number display section 88; a side-BET number display section 89, which displays the number of side-betted coins; and a credit amount display section 90 are provided. In this case, 28 coins are normally betted, 10 coins are side-betted, and then, 500 coins are credited. After that, the “joker 70” is varied to a trigger for a jackpot (FIG. 10A). In general, the role of the “joker 70” is handled as A (Ace) with no suit. As mentioned above, however, the joker 70 is varied to the trigger for the jackpot, and the player can accept jackpot payout.

### <Flow of Gaming>

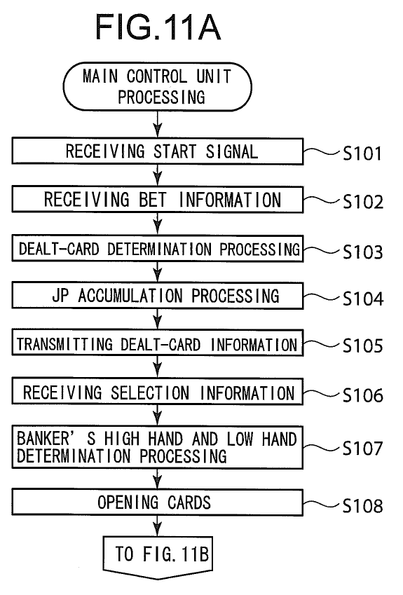

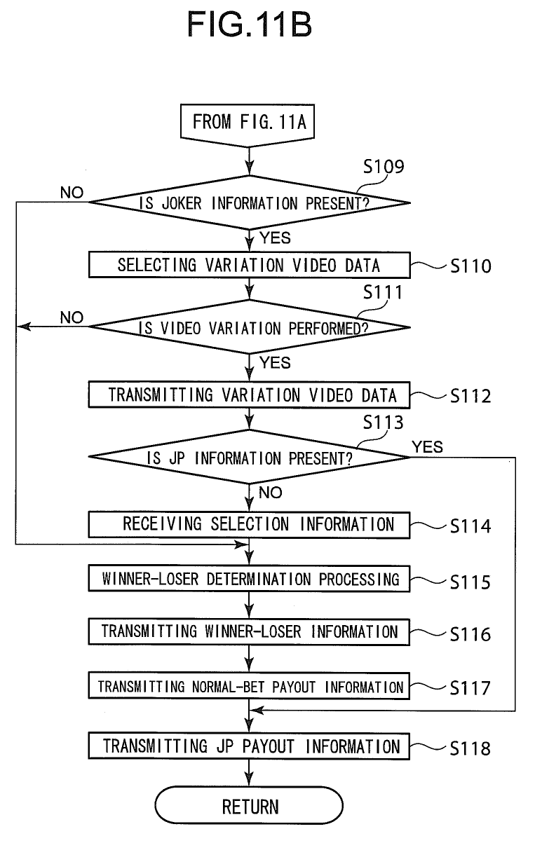

Next, processing operations to be performed at the main control unit 40 and station 3 will be described in detail. FIGS. 11A and 11B are flowcharts each showing main control unit processing to be executed at the main control unit 40 included in the game machine 1 according to the embodiment of the present invention.

As shown in FIG. 11A, the main control unit performs processing of receiving a start signal at the first step S101. In this processing operation, the CPU41 included in the main control unit 40 receives the start signal from any of the stations 3. The start signal serves as a trigger for conducting a PAIGOW poker game in the game machine 1.

Next, at step S102, the CPU41 performs processing of receiving BET information. In this processing operation, the CPU41 receives BET information from the station 3 (see FIG. 2). The BET information is pertinent to BET, and generally includes: information indicative of whether normal BET or side-BET has been performed; and information indicative of amounts of the normal BET and side-BET.

Next, at step S103, the CPU41 performs dealt-card determination processing. In this processing operation, the CPU41 determines seven cards to be dealt to each of the persons consisting of the players and the banker from one group of trump cards, with the use of random numbers. The seven cards determined to be dealt to each of the players at step S103 are equivalent to a predetermined number of the player's cards of the present invention. On the other hand, the seven cards determined to be dealt to the banker is equivalent to a predetermined number of the banker's cards according to the present invention. Further, the front panel display 21 (see FIG. 2) included in the game machine 1 displays in a faced-down manner a card image indicative of the seven banker's cards. Next, at step S104, JP accumulation processing is performed. In this processing operation, the CPU41 handles, as a JP, a predetermined rate of a betted currency value or a side-betted currency value, and then, accumulatively stores the rate in the RAM42, based upon the BET information received at the step S103.

Next, at step S105, dealt-card information transmission processing is performed. In this processing operation, the CPU41 transmits dealt-card information to the station 3. The dealt-card information includes information indicative of kinds of cards determined to be dealt to the players and banker (such as suits (heart, clover, spade, and diamond), and joker 70). The station 3 causes the liquid crystal display 10 to display a card image indicative of the seven player's cards, based upon the received dealt-card information. Further, this station accepts entry for dividing the dealt cards into a group of five cards (high hand) and a group of two cards (low hand).

Next, at step S106, selection information reception processing is performed. In this processing operation, the CPU41 receives selection information from the station 3. The selection information is indicative of which five cards were selected at high hand and which two cards were selected at low hand, from among the dealt seven cards.

Next, at step S107, the CPU41 performs the banker's high hand and low hand determination processing. In this processing operation, the CPU41 performs processing of dividing the seven banker's cards into two groups of cards. In this case, these seven cards are divided into the banker's high and low hands.

Next, at step S108, card opening processing is performed. In this processing operation, the CPU41 controls the front panel display 21 in a faced up manner a card image of the banker's cards indicative of the high and low hands determined at step S107.

Next, as shown in FIG. 11B, at step S109, the CPU41 judges whether or not information of the joker 70 is present. In this processing operation, the CPU41 judges whether or not a predetermined card (joker 70) is present at the player's hand. In a case where the judgment result is affirmative, the routine proceeds to step S110. Otherwise, the routine proceeds to step S115.

At step S110, the CPU41 performs variation video data selection processing. In this processing operation, the CPU41 samples a random number value from among the numeric range of predetermined random number values. This sampling operation is performed based upon the game programs (including a PAIGOW poker game program) stored in the ROM43. Then, this CPU selects one item of variation video data from a table for selecting variation video data, which is stored in the RAM42. This selection is performed based upon the sampled random number value.

Namely, for a duration from the display of cards to the end of a game, processing of determining whether or not to vary the predetermined card included in the player's cards to another kind of card, is executed at a timing after the banker's cards are opened, for example. Another kind of card also includes a symbol for paying a special bonus, the symbol being adapted to receive jackpot payout (see FIG. 10).

Next, at step S111, it is judged whether or not to vary a video image. In this processing operation, the CPU41 judges whether or not the variation video data selected at step S110 varies a predetermined card. In a case where the judgment result is affirmative, the routine proceeds to step S112. Otherwise, the routine proceeds to step S115.

Next, at step S112, the CPU41 performs variation video data transmission processing. In this processing operation, the CPU41 transmits to the station 3 the variation video data stored in the RAM42, via the bus 44, the I/O interface 46, and the communication interface 50.

Next, at step S113, the CPU41 judges whether or not jackpot information is present. In this processing operation, the CPU41 judges whether or not the jackpot information stored in the RAM42 is present. In a case where the judgment result is affirmative, the routine proceeds to step S118. Otherwise, the routine proceeds to step S114.

Next, at step S115, winner-loser determination processing is performed. In this processing operation, the CPU41 executes processing of determining a winner or a loser, based upon the selection information received at step S106 or S114 and the high and low hands determined at step S107. Namely, this CPU executes processing of determining a winner or a loser by comparing the hands of the player's hands divided into two groups with those of the banker's cards.

Specifically, the player's high and low hands are compared with the banker's, it is judged as to which of the dealt cards in combination is strong or weak, and then, a winner or a loser are determined based upon the judgment result. Further specifically, in a case where the player's high and low hands are stronger than the banker's, it is judged to be the player's win; in a case where the banker's high and low hands are stronger than the player's, it is judged to be the banker's win; or in a case where the player is stronger at either one of the high and low hands and the banker is stronger at the other hand, it is judged to be “Draw”.

Next, at step S116, winner-loser information transmission processing is performed. In this processing operation, the CPU41 transmits to the station the information indicative of the winner and loser determined at step S115 (hereinafter, referred to as winner-loser information). At the station 3, upon the receipt of winner-loser information, the liquid crystal display 10 displays any one of the images inclusive of messages “You've won”, “You've lost”, and “Draw”, based upon the received winner-loser information.

Next, at step S117, normal-BET payout information transmission processing is performed. In this processing operation, the CPU41 transmits to the station 3 the normal-BET payout information stored in the RAM42. The normal-BET payout information is indicative of the amount of credit (currency value) to be paid out in response to normal BET. Specifically, in the case of the player's win, this CPU transmits information indicative of credit of which amount is twice of that of normal BET. In the case of “Draw”, this CPU transmits information indicative of credit of which amount is equal to that of normal BET. In the case of the banker's win, further, this CPU transmits information indicative of the fact that the amount of credit to be given is 0.

Next, at step S118, JP payout information transmission processing is performed. In this processing operation, the CPU41 transmits JP payout information to the station 3. The JP payout information is indicative of the amount of credit (currency value) to be paid out in a game or a side game. Specifically, this CPU transmits information indicative of the credit determined based upon combinations of “Royal Flush”, “Straight Flush”, “Four of a Kind”, “Full House”, “Flush”, “Straight”, “Three of a Kind”, “Two Pairs”, “One Pair”, and “No Pair”. The CPU41 terminals main control unit processing upon executing the processing of step S118.

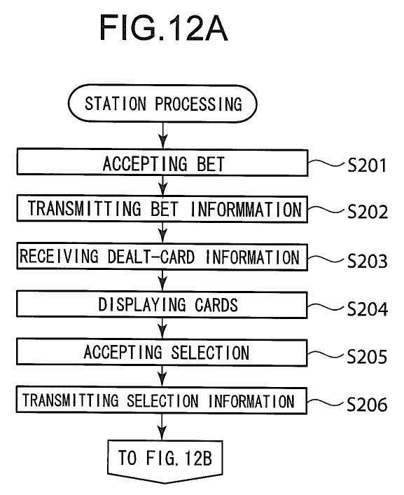

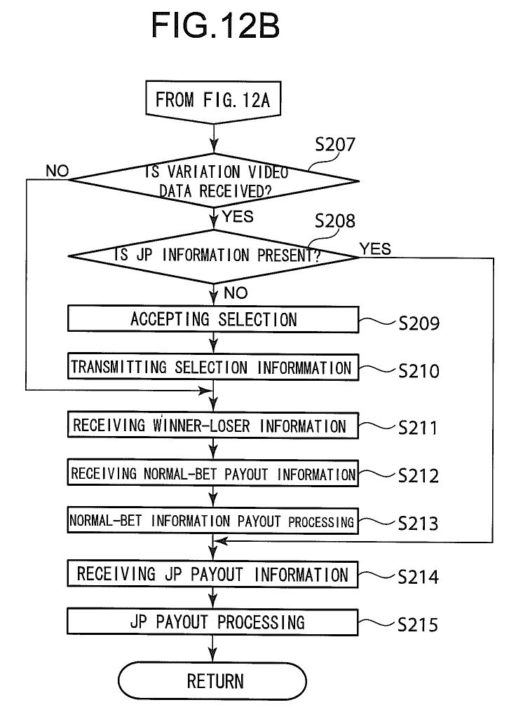

Next, the processing operation performed at the station 3 will be described in detail with referring to the drawings. Because the processing pertinent to the main control unit 40 was already described with referring to FIGS. 11A and 11B, only the processing performed at the station 3 will be described in detail. FIGS. 12A and 12B are flowcharts showing subroutines of the station processing to be executed at the station 3 according to the first embodiment.

First, as shown in FIG. 12A, at step S201, the CPU51 included in the station 3 performs BET acceptance processing. In this processing operation, the CPU51 accepts normal BET and side BET entries.

Next, at step S202, the CPU51 performs BET information transmission processing. In this processing operation, the CPU51 transmits to the main control unit 40 the BET information serving as information pertinent to input BET. Upon the receipt of the BET information, the main control unit 40 determines the cards to be dealt to the players and the banker (see step S102 of FIG. 11A).

Next, at step S203, the CPU51 performs dealt-card information reception processing. In this processing operation, the CPU51 receives from the main control unit 40 the dealt-card information indicative of the cards to be dealt to the players.

Next, at step S204, the CPU51 performs card display processing. In this processing operation, the CPU51 controls a dealt-card display section 83 of the liquid crystal display 10 to display a card image indicative of the seven player's cards. This controlling operation is performed based upon the dealt-card information received at step S203.

Next, at step S205, the CPU51 performs selection acceptance processing. In this processing operation, the CPU51 accepts, via the touch panel 11, an entry for making a selection to divide the player's cards into two groups of cards (high and low hands). Namely, the player can determine the high and low hands from among the dealt cards 72 by operating a high hand determination button 84 and a low hand determination button 85 of the touch panel 11 (input device). The high and low hands of the player's cards are displayed at the high and low hand display sections 80 and 81, respectively (see FIG. 8A). Namely, the CPU51 divides the predetermined number of the player's cards into two groups of cards, based upon input from the input device.

Next, at step S206, the CPU51 performs selection information transmission processing. In this processing operation, the CPU51 transmits to the main control unit 40 the selection information that is based upon selection of the high and low hands. Upon the receipt of selection information, the main control unit 40 executes processing of determining the high and low hands of the banker's cards, followed by determining a winner or a loser (see step S107 of FIG. 11A).

Next, as shown in FIG. 12B, at step S207, the CPU51 determines whether or not variation video data has been received. In this processing operation, the CPU51 judges whether or not variation video data has been received from the main control unit 40. In a case where the judgment result is affirmative, the routine proceeds to step S208. Otherwise, the routine proceeds to step S211.

Next, at step S208, the CPU51 judges whether or not JP information is present. In this processing operation, the CPU51 judges whether or not the variation video data transmitted from the main control unit 40 at step S207 is a JP payout trigger. In a case where the judgment result is affirmative, the routine proceeds to step S214. Otherwise, the routine proceeds to step S209.

Next, at step S209, the CPU51 performs selection acceptance processing. In this processing operation, the CPU51 accepts entries for selecting high and low hands. The player can select the high and low hands via the touch panel 11. Namely, the CPU51 divides the predetermined number of the player's cards into two groups of cards, based upon input from the input device.

Next, at step S210, the CPU51 performs selection information transmission processing. In this processing operation, the CPU51 transmits to the main control section 40 the selection information that is based upon selection of the high and low hands. Upon the receipt of selection information, the main control section 40 executes processing of determining a winner or a loser (see step S107 of FIG. 11A).

Next, at step S211, the CPU51 performs winner-loser information reception processing. In this processing operation, the CPU51 receives winner-loser information from the main control unit 40. Subsequently, the dealt-card display section 83 of the liquid crystal display 10 displays any one of the images inclusive of messages “You've won”, “You've lost”, and “Draw”, based upon the received winner-loser information at a predetermined time (10 seconds in the first embodiment).

Next, at step S212, the CPU51 performs normal-BET payout information reception processing. In this processing operation, the CPU51 receives normal-BET payout information from the main control unit 40. Upon the receipt of the normal-BET payout information, the CPU51 stores in the RAM52 the credit data that is based upon the normal-BET payout information.

Next, at step S213, the CPU51 performs normal-BET payout processing. In this processing operation, the CPU51 performs payout, based upon the normal-BET payout processing received at step S212.

Next, at step S214, the CPU51 receives jackpot payout information from the main control unit 40. Upon the receipt of the jackpot payout information, the CPU51 stores in the RAM52 the credit data that is based upon the received jackpot payout information.

Next, at step S215, the CPU51 performs jackpot payout processing. In this processing operation, the CPU51 pays out credit, based upon the jackpot payout information received at step S214. After executing the processing of step S215, the CPU51 terminates this subroutine.

While the first embodiment described a case of dividing respective ones of the seven player's cards and the seven banker's cards into a group of five cards and a group of two cards, the present invention is not limitative thereto.

While the first embodiment described a case of performing a PAIGOW poker, the present invention is not limitative thereto in particular, as long as a game is performed such that the players and the banker complete against each other with the use of the players' cards and the banker's card. For example, apart from the PAIGOW poker, games such as blackjack, a Draw poker, baccarat, a Let It Ride, and a Caribbean Stud poker may also be performed.

While the first embodiment described a case of employing trump cards, the present invention is not limitative thereto. For example, cards such as tarot cards, trading cards, mah-jongg cards, domino cards, and its analogous (such as mah-jongg tiles, for example) may be employed as long as they can be provided in games.

While the first embodiment described a case in which the dealer takes over the banker, one player may take over the banker if a plurality of players participate in games in the present invention.

While the first embodiment described a case in which the player performs the PAIGOW poke while visually recognizing the liquid crystal display 10 included in the station 3, the game machine of the present invention may be provided with either of a main monitor and a liquid crystal display (included in a station). In this configuration, the dealer's (banker's) cards and the player's cards may be displayed on the main monitor or station display.

While the present embodiment described a case in which the joker 70 is varied on condition that the player performs BET, this joker may be varied on condition that the player performs side-BET.

In the first embodiment, the method for playing card games is implemented by the CPU executing it.

While the embodiment according to the present invention has been described, the description presents only some of the specific examples and is not intended to limit the present invention in any way and specific constructions of each means and the like can be properly changed in terms of design. Besides, the effects described in the embodiment of the present invention are only the most preferable effects generated from the present invention and the effects to be caused by the present invention is not limitative thereto.

The more important features of the invention have thus been outlined, rather broadly, in order that the aforementioned detailed description thereof may be better understood, and in order that the present contribution to the art may be better appreciated. There are, of course, additional features of the invention that were described above and which formed the subject matter of the claims appended hereto. In this respect, upon explaining at least one embodiment of the invention in detail, it is to be understood that the invention is not limitative in its application to the details of construction and to the arrangements of the components set forth in the aforementioned description or illustrated in the drawings. According to the invention, other embodiments can be variously practiced and carried out as well. Also, it is to be understood that the phraseology and terminology employed herein are merely intended for the descriptive purpose and should not be regarded as limiting. As such, those skilled in the art will appreciate that the conception, upon which this disclosure is based, may readily be utilized as a basis for the designing of other systems and methods for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way. These matters together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matters in which there are illustrated preferred embodiments of the invention.

The detailed descriptions aforementioned may be presented in terms of program procedures executed on a computer or network of computers. These procedural descriptions and representations are the means used by those skilled in the art to most effectively convey the substance of their work to others skilled in the art. A procedure is here, and generally, conceived to be a self-consistent sequence of steps leading to a desired result. These steps require physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities. Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine and/or manual operations. Useful machines for performing the operation of the present invention include general purpose digital computers or similar devices. The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general-purpose machines may be used with programs written in accordance with the teachings herein, or it may prove more convenient to construct more specialized apparatus to perform the required method steps. The required structure for a variety of these machines will appear from the description given.

What is claimed is:

1. A method of playing card games, comprising the steps of:
(a) dealing a predetermined number of cards as player's cards and dealing a predetermined number of cards as banker's cards from among plural types of cards;
(b) varying a predetermined card included in the player's cards to another kind of card at a predetermined timing for a duration from dealing of cards to an end of a game in the step (a) in a case where the player's cards include the predetermined card; and
(c) determining a winner or a loser by comparing hands of the player's cards with hands of the banker's cards.

2. The method of playing card games, according to claim 1, wherein:
the step (b) comprises the step of varying the predetermined card included in the player's cards to another kind of card in a case where an input is made from an input device for accepting the player's operation.

3. The method of playing card games, according to claim 1, wherein:
the step (b) comprises the step of varying the predetermined card included in the player's cards to a card inclusive of a symbol for paying a special bonus.

4. A method of playing card games, comprising the steps of:
(a) dealing a predetermined number of cards as player's cards and dealing a predetermined number of cards as banker's cards from among plural kinds of cards;
(b) varying a predetermined card included in the player's cards to another kind of card at a predetermined timing for a duration from dealing of cards to an end of a game in the step (a) in a case where the player's cards include the predetermined card and in a case where an input is made from an input device for accepting the player's operation; and
(c) determining a winner or a loser by comparing hands of the player's cards and hands of the banker's cards.

5. The method of playing card games, according to claim 4, wherein:
the step (b) comprises the step of varying the predetermined card included in the player's cards to a card inclusive of a symbol for paying a special bonus.

6. A method of playing card games, comprising the steps of:
(a) dealing a predetermined number of cards as player's cards and dealing a predetermined number of cards as banker's cards from among plural types of the cards;
(b) dividing the predetermined number of player's cards into two groups of cards;
(c) dividing the predetermined number of banker's cards into two groups of cards;
(d) varying the predetermined card included in the player's cards to another type of card at a predetermined timing in a case where the player's cards divided into the two groups include the predetermined card for a duration from dealing of cards to an end of a game in the step (a); and
(e) determining a winner or a loser by comparing hands of the player's cards divided into the two groups with hands of the banker's cards divided into the two groups.

7. The method of playing card games, according to claim 6, wherein:
the step (d) comprises the step of varying the predetermined card included in the player's cards to another kind of card in a case where an input is made from an input device for accepting the player's operation.

8. The method of playing card games, according to claim 6, wherein:
the step (d) comprises the step of varying the predetermined card included in the player's cards to a card inclusive of a symbol for paying a special bonus.

9. A method of playing card games, comprising the steps of:
(a) dealing a predetermined number of cards as player's cards and dealing a predetermined number of cards as banker's cards from among plural types of cards;
(b) dividing the predetermined number of player's cards into two groups of cards;
(c) dividing the predetermined number of banker's cards into two groups of cards;
(d) varying a predetermined card included in the player's cards to another kind of card at a predetermined timing for a duration from dealing of cards to an end of a game in the step (a) in a case where the player's cards include the predetermined card and in a case where an input is made from an input device for accepting the player's operation; and
(e) determining a winner or a loser by comparing hands of the player's cards divided into the two groups with hands of the banker's cards divided into the two groups.

10. The method of playing card games, according to claim 9, wherein:
the step (d) comprises the step of varying the predetermined card included in the player's cards to a card inclusive of a symbol for paying a special bonus.

11. A game machine, comprising:
a display device for displaying plural kinds of cards;
an input device for accepting a player's operation;
a memory for storing variation video data for varying a predetermined card of plural kinds of cards to another kind of card; and
a processor for controlling the display device, the input device, and the memory, the processor being programmed to execute processing operations of:
(a) displaying a predetermined number of player's cards and a predetermined number of banker's cards on the display device;
(b) varying a predetermined card included in the player's cards to another kind of card at a predetermined timing, based upon the variation video data stored in the memory, in a case where the player's cards include the predetermined card for a duration from dealing of cards to an end of a game in the process (a); and
(c) determining a winner or a loser by comparing hands of the player's cards with hands of the banker's cards, the cards being divided into two groups.

12. The game machine according to claim 11, wherein:
the processor varies the predetermined card included in the player's cards to another kind of card, based upon the variation video data stored in the memory in a case where an input is made from the input device in the process (b).

13. The game machine according to claim 11 or 12, wherein:
the processor varies the predetermined card included in the player's cards to a card inclusive of a symbol for paying a special bonus in (b).

14. A game machine, comprising:
a display device for displaying plural kinds of cards;
an input device for accepting a player's operation;
a memory for storing variation video data for varying a predetermined card of plural kinds of cards to another kind of card; and
a processor for controlling the display device, the input device, and the memory, the processor being programmed to execute processing operations of:
(a) displaying a predetermined number of player's cards and a predetermined number of banker's cards on the display device;
(b) varying a predetermined card included in the player's cards to another kind of card at a predetermined timing, based upon the variation video data stored in the memory, in a case where the player's cards include the predetermined card and in a case where an input is made from the input device for a duration from dealing of cards to an end of a game in the process (a); and
(c) determining a winner or a loser by comparing hands of the player's cards with hands of the banker's cards.

15. The game machine according to claim 14, wherein:
the processor varies the predetermined card included in the player's cards to a card inclusive of a symbol for paying a special bonus in the process (b).

16. A game machine, comprising:
a display device for displaying plural kinds of cards;
an input device for accepting a player's operation;
a memory for storing variation video data for varying a predetermined card of plural kinds of cards to another kind of card; and
a processor for controlling the display device, the input device, and the memory, the processor being programmed to execute processing operations of:
(a) displaying a predetermined number of player's cards and a predetermined number of banker's cards on the display device;
(b) varying a predetermined card included in the player's cards to a card inclusive of a symbol for paying a special bonus at a predetermined timing, based upon the variation video data stored in the memory, in a case where the player's cards include the predetermined card and in a case where an input is made from the input device for a duration from dealing of cards to an end of a game in the process (a); and
(c) determining a winner or a loser by comparing hands of the player's cards with hands of the banker's cards, the cards being divided into the two groups.

17. A game machine, comprising:
a display device for displaying plural kinds of cards;
an input device for accepting a player's operation;
a memory for storing variation video data for varying a predetermined card of plural kinds of cards to another kind of card; and
a processor for controlling the display device, the input device, and the memory, the processor being programmed to execute processing operations of:
(a) displaying a predetermined number of player's cards and a predetermined number of banker's cards on the display device;
(b) dividing the predetermined number of player's cards into two groups of cards;
(c) dividing the predetermined number of banker's cards into two groups of cards;
(d) varying a predetermined card included in the player's cards to another kind of card at a predetermined timing, based upon the variation video data stored in the memory, in a case where the player's cards include the predetermined card for a duration from dealing of cards to an end of a game in (a); and
(e) determining a winner or a loser by comparing hands of the player's cards divided into the two groups with hands of the banker's cards divided into the two groups.

18. The game machine according to claim 17, wherein:
the processor varies the predetermined card to another kind of card, based upon the variation video data stored in the memory, in a case where an input is made from the input device in the processing (d).

19. The game machine according to claim 17 or 18, wherein:
the processor varies the predetermined card included in the player's cards to a card inclusive of a symbol for paying a special bonus in the processing (d).

20. A game machine, comprising:
a display device for displaying plural kinds of cards;
an input device for accepting a player's operation;
a memory for storing variation video data for varying a predetermined card of plural kinds of cards to another kind of card; and
a processor for controlling the display device, the input device, and the memory, the processor being programmed to execute processing operations of:
(a) displaying a predetermined number of player's cards and a predetermined number of banker's cards on the display device;
(b) dividing the predetermined number of player's cards into two groups of cards;
(c) dividing the predetermined number of banker's cards into two groups of cards;
(d) varying a predetermined card included in the player's cards to a card inclusive of a symbol for paying a special bonus at a predetermined timing, based upon the variation video data stored in the memory, in a case where the player's cards include the predetermined card and in a case where an input is made from an input device for accepting the player's operation, for a duration from dealing of cards to an end of a game in the process (a); and
(e) determining a winner or a loser by comparing hands of the player's cards divided into the two groups with hands of the banker's cards divided into the two groups.

21. The game machine according to claim 20, wherein:
the processor varies the predetermined card included in the player's cards to a card inclusive of a symbol for paying a special bonus in the process (d).

22. A game machine, comprising:
a display device for displaying plural kinds of cards;
an in for a duration from dealing of cards to an end of a game in the process (a)ut device for accepting a player's operation;
a memory for storing variation video data for varying a predetermined card of plural kinds of cards to another kind of card; and
a processor for controlling the display device, the input device, and the memory, the processor being programmed to execute processing operations of:
(a) displaying a predetermined number of player's cards and a predetermined number of banker's cards on the display device;
(b) dividing the predetermined number of player's cards into two groups of cards;
(c) dividing the predetermined number of banker's cards into two groups of cards;
(d) varying a predetermined card included in the player's cards to a card inclusive of a symbol for paying a special bonus at a predetermined timing, based upon the variation video data stored in the memory, in a case where the player's cards include the predetermined card and in a case where an input is made from an input device for accepting the player's operation, for a duration from dealing of cards to an end of a game in the process (a); and
(e) determining a winner or a loser by comparing hands of the player's cards divided into the two groups with hands of the banker's cards, the cards being divided into the two groups.
